(19) United States
(12) Patent Application Publication
(10) Pub. No.: US 2008/0062378 A1
(43) Pub. Date: Mar. 13, 2008

(54) GLASSES WITH REMOVABLE LENS LAYERS

(76) Inventor: Brian McCracken, San Clemente, CA (US)

Correspondence Address: DOVAS LAW P.C., 307 BAINBRIDGE STREET, PHILADELPHIA, PA, 19147, US

(21) Appl. No.: 11/851,393

(22) Filed: Sep. 7, 2007

Related U.S. Application Data
(60) Provisional application No. 60/824,899, filed on Sep. 7, 2006.

(51) Int. Cl. G02C 9/04

(52) U.S. Cl. 351/57

(57) ABSTRACT

A pair of glasses is provided. The pair of glasses includes a frame, a first lens layer connected to the frame, a second lens layer in removable contact with the first lens layer, and a third lens layer in removable contact with the second lens layer. Further provided is a pair of glasses including an elastically deformable frame including a first groove and a second groove. Further provided is a method of changing the optical properties of a pair of glasses or removing imperfections from an optical view area of a pair of glasses.

### CROSS REFERENCE TO RELATED APPLICATION(S)

This application claims the benefit of U.S. provisional application No. 60/824,899, filed Sep. 7, 2006, which is incorporated by reference as if fully set forth.

### BACKGROUND

Glasses, including corrective glasses, sunglasses and the like, are often prone to damage due to their innately personal nature. Even when a user spends a considerable amount of money to purchase a quality pair of glasses, the glasses often end up unprotected at the bottom of a pocket or purse or are otherwise treated in a precarious manner. Accordingly, the lenses of glasses are usually quickly scratched, requiring a user to purchase new glasses or otherwise suffer poor visibility. Scratch resistant coatings offer some protection, but invariably fail to prevent scratches from occurring.

In view of the above, it would be desirable to provide a pair of glasses which allow lens scratches to be easily remedied. Further it would be desirable that such remedy be inexpensive and easy to implement by all users.

### SUMMARY

The present invention provides a pair of glasses including a frame, a first lens layer connected to the frame, a second lens layer in removable contact with the first lens layer, and a third lens layer in removable contact with the second lens layer.

The present invention further provides a pair of glasses including an elastically deformable frame including a first groove and a second groove. A first lens layer is attached to the frame in the first groove, and a second lens layer is removably attached to the frame in the second groove. The second lens layer is releasable from the second groove.

The present invention further provides a method of changing the optical properties of a pair of glasses or removing imperfections from an optical view area of a pair of glasses. The method includes providing a frame, a first lens layer, and a second lens layer. The first lens layer is connected to the frame, and the second lens layer is removably connected to the frame adjacent to the first lens layer. The second lens layer is removed by elastically deforming the frame by application of a bending force or a torsioning force.

### BRIEF DESCRIPTION OF THE DRAWING(S)

The following detailed description will be readily understood in conjunction with the appended drawings which illustrate preferred embodiments of the invention. In the drawings:

FIG. 1 is a perspective view of a pair of glasses according to a first preferred embodiment of the present invention.

FIG. 2 is a partial front elevation view of the pair of glasses of FIG. 1.

FIG. 3 is a section view taken along line 3-3 of FIG. 2.

FIG. 4 is a partial front elevation view of a pair of glasses according to a second preferred embodiment of the present invention.

FIG. 5 is a section view taken along line 5-5 of FIG. 4.

FIG. 6 is a perspective view of a pair of glasses according to a third preferred embodiment of the present invention.

FIG. 7 is a partial front elevation view of the pair of glasses of FIG. 6.

FIG. 8 is a section view taken along line 8-8 of FIG. 7.

FIG. 9 is a perspective view of a pair of glasses according to a fourth preferred embodiment of the present invention.

FIG. 10 is a section view taken along line 10-10 of FIG. 9.

FIG. 11 is a flowchart showing a method of providing glasses according to a preferred embodiment of the present invention.

### DETAILED DESCRIPTION OF THE PREFERRED EMBODIMENT(S)

Certain terminology is used in the following description for convenience only and is not limiting. The words “right,” “left,” “top,” and “bottom” designate directions in the drawings to which reference is made. The words “a” and “one” are defined as including one or more of the referenced item unless specifically stated otherwise. This terminology includes the words above specifically mentioned, derivatives thereof, and words of similar import. The phrase “at least one” followed by a list of two or more items, such as A, B, or C, means any individual one of A, B or C as well as any combination thereof.

The preferred embodiments of the present invention are described below with reference to the drawing figures where like numerals represent like elements throughout.

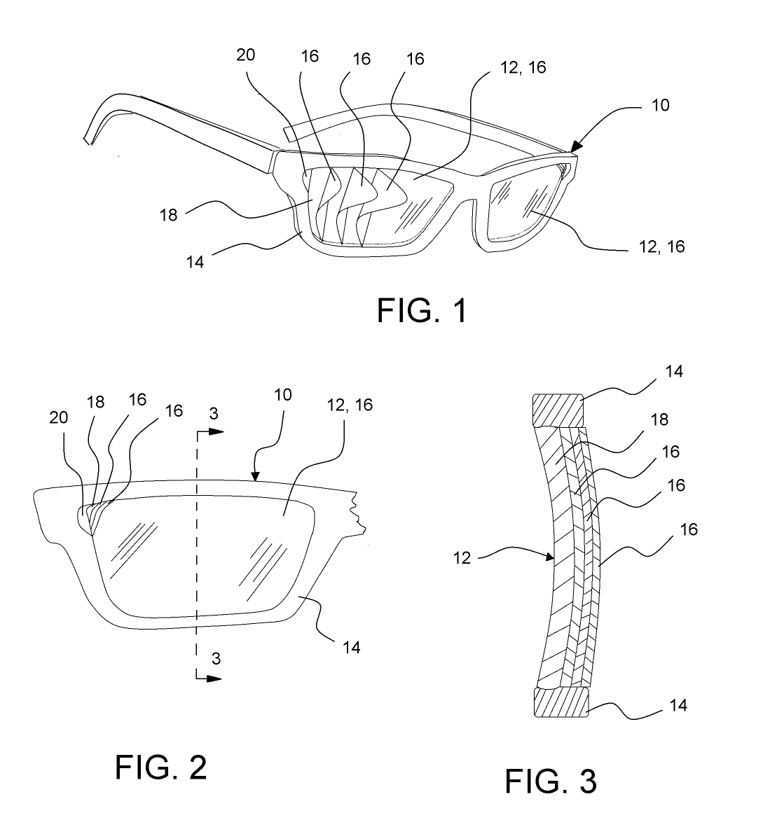

Referring to FIGS. 1-3, a pair of glasses 10 according to a first preferred embodiment of the present invention is shown. The pair of glasses 10 include a composite lens 12 connected with a frame 14. The glasses 10 are configured for wearing on the face of a user in a conventional manner.

The lens 12 includes a plurality of transparent removable lens layers 16 connected to a transparent base lens layer 18 and positioned one on top of another. The base lens layer 18 includes a rigid lens fixedly attached to the frame 14. The rigid lens of the base lens layer 18 preferably includes a polymeric material such as CR-39 plastic, high index plastic, or polycarbonate. Alternatively, any suitable material including glass or polymeric material can be provided for forming the base lens layer 18. The rigid lens of the base lens layer 18 can include tinting, such that the glasses 10 function as sunglasses, and/or geometry conducive to correcting visual impairment. The base lens layer 18 also preferably includes one or more of an antireflective coating/film, polarizing coating/film, scratch resistant coating/film and mirror coating/film.

Each of the removable lens layers 16 is preferably a thin flexible transparent lens which is removably adhered to one of the base lens layer 18 and an adjacent removable lens layer 16 via electrostatic attraction. FIG. 1 shows a manner in which each of the removable layers 16 can be peeled away from an underlying portion of the composite lens 12. Alternatively, the removable lens layers 16 can be rigid or semi-rigid, and they can be adhered to an underlying layer using a non-aggressive type adhesive. Each removable lens layer 16 is preferably formed of a polymeric material such as polyethylene, polystyrene, polyester, or any suitable transparent polymeric material. While three removable lens layers 16 are shown, any suitable number of removable lens layers can be provided, but preferably two or more removable lens layers are provided.

Each of the removable lens layers 16 are preferably clear lenses without substantial light modifying properties. Accordingly, the base lens layer 18 generally defines the optical properties of the composite lens 12, and the removal of the removable lens layers 16 does not substantially affect the optical properties of the composite lens 12. Alternatively, the removable lens layers 16 can be formed with one or more of anti-reflecting, polarizing, tinting and mirroring properties, such that a removal of one of the removable lens layers 16 substantially alters the optical properties of the composite lens 12.

As shown in detail in FIG. 2, the removable lens layers 16 are preferably nested with a leading edge of each lens layer 16 offset from a leading edge of an underlying removable lens layer 16. Accordingly, the leading edge of each removable lens layer 16 is accessible and generally visible to a user. The user can grab the leading edge of a top one of the removable lens layers 16, using a finger, a finger nail or other implement, and remove the top one of the removable lens layers 16. In this manner, an underlying one of the removable lens layers 16 is revealed, or if the bottommost removable lens layer 16 is removed, the base lens layer 18 is revealed. Alternatively, other features can be provided on the removable lens layers 16 to facilitate their removal, and/or the glasses 10 can be provided without nested offset leading edges on the removable lens layers 16 or only slightly offset leading edges barely visible to the naked eye.

An indentation 20 is preferably provided in the frame 14 to facilitate manual removal of the removable lens layers 16 by permitting a user to insert a finger or other implement in proximity to the leading edges of the removable lens layers 16.

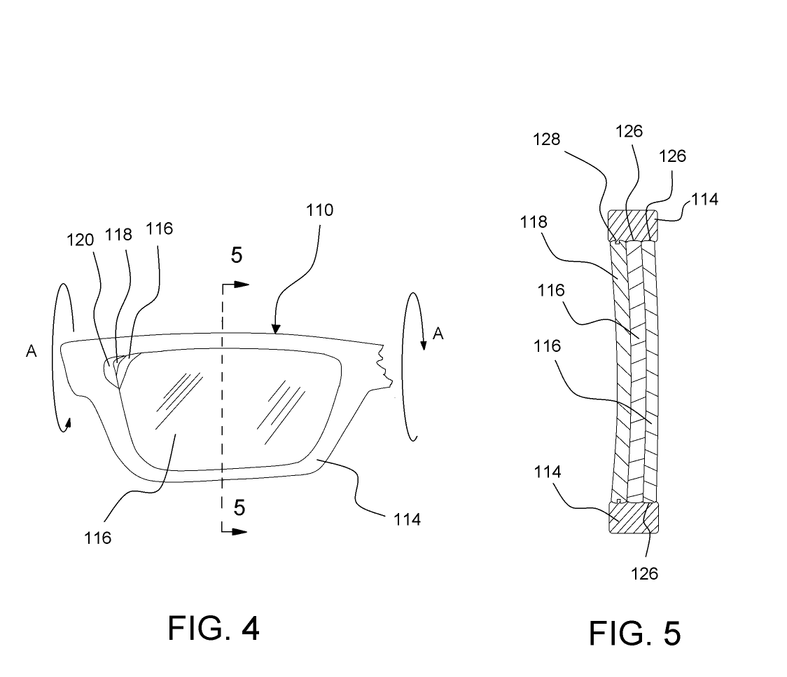

Referring to FIGS. 4 and 5, a pair of glasses 110 according to a second preferred embodiment of the present invention is shown. The glasses 110 include a frame 114 which houses removable lens layers 116 and a base lens layer 118.

Each of the removable lens layers 116 and the base lens layer 118 include a rigid lens attached to the frame 114. The rigid lenses are preferably formed from a suitable polymeric material. The base lens layer 118 can include tinting, such that the glasses 110 function as sunglasses, and/or geometry conducive to correcting visual impairment. The base lens layer 118 also preferably includes one or more of an antireflective coating/film, polarizing coating/film, scratch resistant coating/film and mirror coating/film. Each of the removable lens layers 116 are preferably clear lenses without substantial light modifying properties. Alternatively, one or both of the removable lens layers 116 include one or more of tinting, corrective geometry, antireflective coating/film, polarizing coating/film, scratch resistant coating/film and mirror coating/film.

The frame 114 preferably includes first and second grooves 126 for removably retaining the removable lens layers 116 and a third groove 128 for generally permanently retaining the base lens layer 118. The third groove 128 is more aggressive than the first and second grooves 124 to prevent accidental dislodgement of the base lens layer 118 from the frame 114 to generally permanently retain the base lens layer 118. Preferably, the lens layers 116, 118 are subject to bending moment induced stresses causing a reasonable degree of elastic deformation to assure that they are rigidly secured in their respective grooves 126, 128. Alternatively, the third groove 128 for the base lens layer 118 can be configured the same as the second groove 126 to facilitate removal of the base lens layer 118.

The removable lens layers 116 are preferably nested with a leading edge of each removable lens layer 116 offset from a leading edge of an underlying removable lens layer 116 or a leading edge of the base layer. Accordingly, the leading edge of each removable lens layer 116 is accessible and visible, at least under close inspection, to a user. The user can grab the leading edge of a top one of the removable lens layers 116, using a finger, a finger nail or other implement, to dislodge the one of the removable lens layers 116 from its respective groove 126. The frame 114 is preferably formed of a substantially elastically deformable material to permit a user to apply a torque “A” or other load to elastically distort the frame 114 to selectively dislodge one or both of the removable lens layers 116. Alternatively, the glasses 110 can be provided without nested offset leading edges on the removable lens layers 116 and/or without a significantly elastically deformable frame 114.

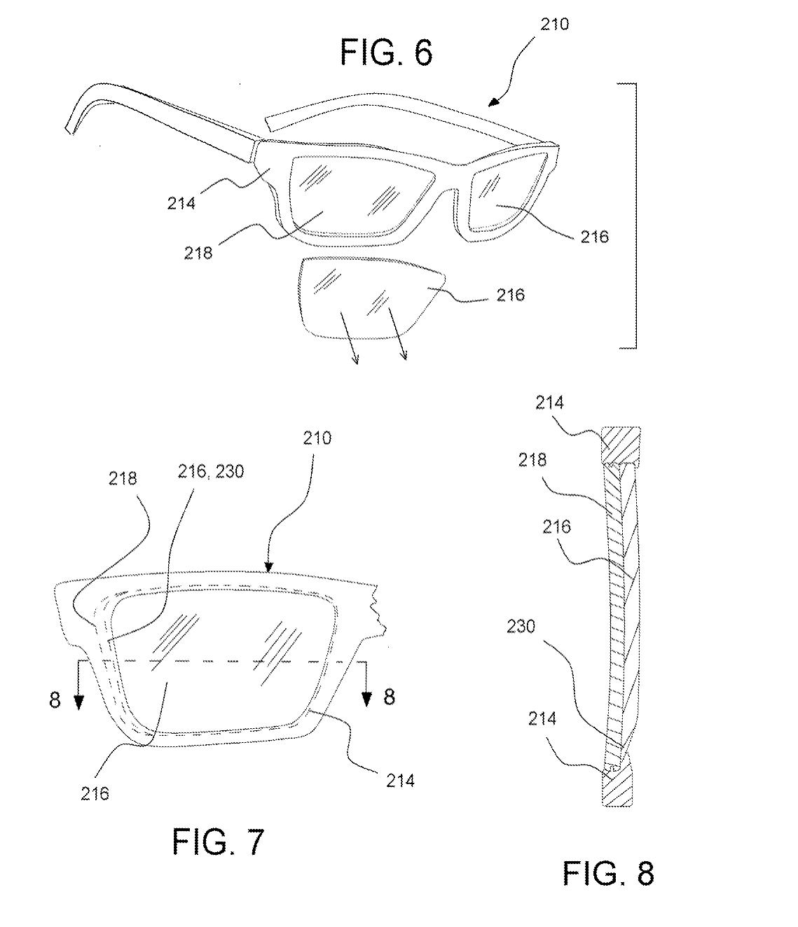

Referring to FIGS. 6 through 8, a pair of glasses 210 according to a third preferred embodiment of the present invention is shown. The glasses 210 include a frame 214 which houses a removable lens layer 216 and a base lens layer 218. The removable layer 216 includes a leading edge 230 which is offset from a leading edge of the base lens layer 218. Preferably, the leading edge 230 has a reduced cross-section as shown in FIG. 8 to facilitate its removal from the frame 214. Preferably, the lens layers 216, 218 are subject to bending moment induced stresses causing a reasonable degree of elastic deformation to assure that they are rigidly secured in the frame 214. As depicted, the removable lens layer 216 can be removed by application of a torque, for example a torque of the type shown in FIG. 4, or alternatively, it can be removed by any suitable distorting force applied to the frame 214. The removable layer 216 can also be removed by using a finger nail or other implement to free the leading edge 230 from the frame 214.

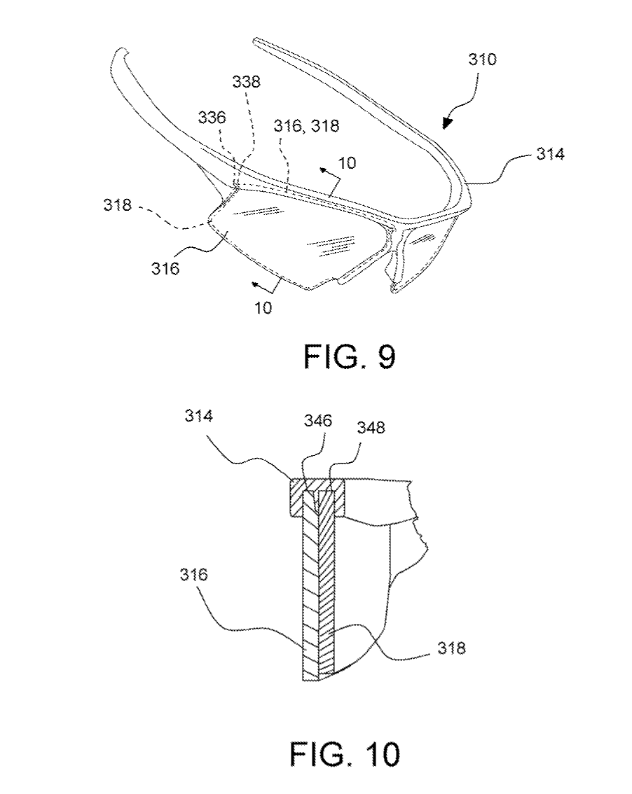

Referring to FIGS. 9 and 10, a pair of glasses 310 according to a fourth preferred embodiment of the present invention is shown. The glasses 310 include a frame 314 which houses a first lens layer 316 and a second lens layer 318. A bottom edge of the first lens layer 316 preferably extends past a bottom edge of the second lens layer 318 as shown. The first lens layer 316 and second lens layer 318 respectively include a first lens layer tab 336 and second lens layer tab 338. The tabs 336, 338 fit into respective recesses respectively positioned within a first groove 346 and a second groove 348 in the frame 314.

Preferably, the lens layers 316, 318 are subject to bending moment induced stresses in the frame 314 causing a reasonable degree of elastic deformation to assure that they are rigidly secured in the frame 314. As configured, preferably each of the lens layers 316, 318 can be removed by application of a bending force on one of the lens layers 316, 318 and/or a torque applied on the frame 314, for example a torque of the type shown in FIG. 4. Alternatively, any suitable distorting force can be applied to the frame 314 or lens layers 316, 318 to remove the lens layers 316, 318. While both lens layers 316, 318 are depicted as removable, alternatively only one of the lens layers 316, 318 can be configured as removable, the other being configured as substantially permanently attached to the frame 314.

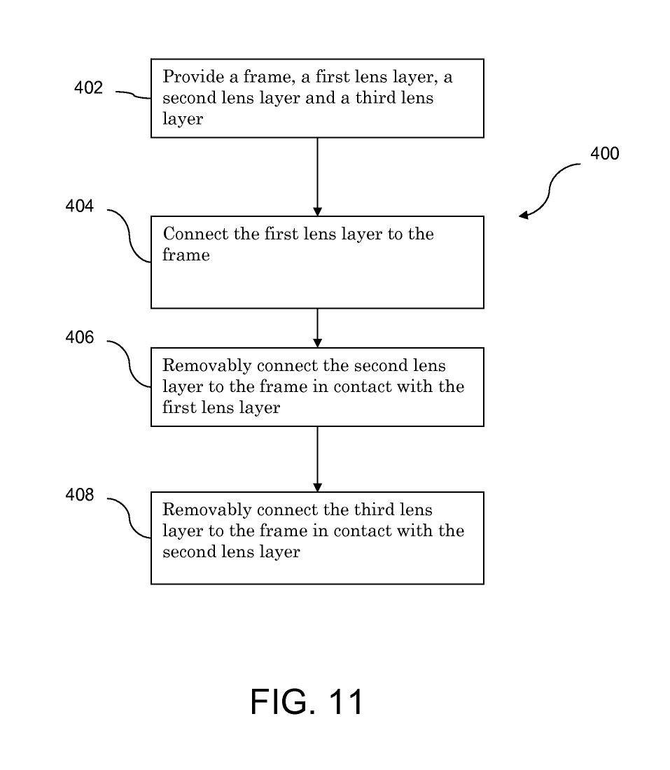

Referring to FIG. 11, a method 400 for providing a pair of glasses is shown. The method includes providing a frame, a first lens layer, a second lens layer and a third lens layer (step 402). The first lens layer is connected to the frame (step 404). The second lens layer is removably connected to the frame in contact with the first lens layer (step 406). The third lens layer is removably connected to the frame in contact with the second lens layer (step 408).

The invention according to the above-described preferred embodiments is useful to allow a user to remove scratched, damaged or otherwise imperfect removable lens layers 16, 116, 216, 316, 318 such that clarity of the glasses 10, 110, 210, 310 is not hindered. Further, in the case where the removable lens layers 16, 116, 216, 316, 318 are provided with special optical properties, for example tinting or mirroring, a user can change the optical properties of the glasses 10, 110, 210, 310 as desired simply by removing the removable layers 16, 116, 216, 316, 318.

While the preferred embodiments of the invention have been described in detail above, the invention is not limited to the specific embodiments described above, which should be considered as merely exemplary. Further modifications and extensions of the present invention may be developed, and all such modifications are deemed to be within the scope of the present invention as defined by the appended claims.

What is claimed is:

1. A pair of glasses comprising:
a frame;
a first lens layer connected to the frame;
a second lens layer in removable contact with the first lens layer; and
a third lens layer in removable contact with the second lens layer.

2. The pair of glasses according to claim 1, wherein the second lens layer comprises a flexible transparent lens removably adhered to the first lens layer via electrostatic attraction, and wherein the third lens layer comprises another flexible transparent lens removably adhered to the second lens layer via electrostatic attraction.

3. The pair of glasses according to claim 1, wherein the second lens layer comprises a flexible transparent lens removably adhered to the first lens layer via an adhesive, and wherein the third lens layer comprises another flexible transparent lens removably adhered to the second lens layer via an adhesive.

4. The pair of glasses according to claim 1, wherein the first lens layer generally defines the optical properties of the pair of glasses, and at least one of the second lens layer and the third lens layer comprises substantially no light modifying properties.

5. The pair of glasses according to claim 4, wherein the first lens layer is formed with at least one of anti-reflecting, polarizing, tinting and mirroring properties.

6. The pair of glasses according to claim 1, wherein at least one of the second lens layer and the third lens layer is formed with at least one of anti-reflecting, polarizing, tinting and mirroring properties.

7. The pair of glasses according to claim 1, wherein the second lens layer and the third lens layer are nested with a leading edge of the second lens layer offset from a leading edge of the first lens layer, and with a leading edge of the third lens layer offset from the leading edge of the second lens layer.

8. The pair of glasses according to claim 1, wherein the frame comprises an indentation adjacent to an edge of the second lens layer and an edge of the third lens layer for facilitating removal of the second lens layer and the third lens layer.

9. The pair of glasses according to claim 1, wherein
the first lens layer, the second lens layer, and the third lens layer are substantially rigid;
the frame comprises a plurality of grooves in which the first lens layer, the second lens layer, and the third lens layer are retained; and
the frame is configured to elastically deform and selectively release at least one of the first lens layer, the second lens layer, and the third lens layer from at least one of the plurality of grooves upon application of at least one of a bending force and a torsioning force.

10. A pair of glasses comprising:
an elastically deformable frame comprising a first groove and a second groove;
a first lens layer attached to the frame in the first groove; and
a second lens layer removably attached to the frame in the second groove, wherein the second lens layer is releasable from the second groove.

11. The pair of glasses according to claim 10, wherein the second lens layer is releasable from the second groove upon application of at least one of a bending force and a torsioning force to the frame.

12. The pair of glasses according to claim 10, wherein the frame comprises an indentation adjacent to a leading edge of the second lens layer for facilitating removal of the second lens layer.

13. The pair of glasses according to claim 10, wherein the second lens layer comprises a leading edge offset from a leading edge of the first lens layer and outside of the second groove for facilitating removal of the second lens layer by an application of force to the leading edge of the second lens layer.

14. The pair of glasses according to claim 10, wherein the second lens layer comprises a leading edge having a reduced cross-section, and at least a portion of the reduced cross-section is positioned with the second groove.

15. The pair of glasses according to claim 10, wherein at least one of the first lens layer and the second lens layer comprises a tab along a leading edge thereof, and at least one of the first groove and the second groove comprises an indentation corresponding to the tab, wherein the tab is configured for retaining the at least one of the first lens layer and the second lens layer within the frame.

16. A method of changing the optical properties of a pair of glasses or removing imperfections from an optical view area of a pair of glasses, the method comprising:
providing a frame, a first lens layer, and a second lens layer, wherein the first lens layer is connected to the frame; and the second lens layer is removably connected to the frame adjacent to the first lens layer; and
removing the second lens layer by elastically deforming the frame by application of at least one of a bending force and a torsioning force.

17. The method of claim 16, further comprising providing the second lens layer with an exposed leading edge, and removing the second lens layer by an application of force to an exposed leading edge of the second lens layer.

18. The method of claim 16, further comprising providing the frame with a third lens layer removably connected to the frame adjacent to the second lens layer, and sequentially removing the third lens layer and the second lens layer by elastically deforming the frame.
